(19) United States
(12) Patent Application Publication
(10) Pub. No.: US 2012/0092492 A1
(43) Pub. Date: Apr. 19, 2012

(54) MONITORING TRAFFIC FLOW WITHIN A CUSTOMER SERVICE AREA TO IMPROVE CUSTOMER EXPERIENCE

(75) Inventors: LEE A. CARBONELL, FLOWER MOUND, TX (US); JEFFREY L. EDGINTON, KELLER, TX (US); PANDIAN MARIADOSS, ALLEN, TX (US)

(73) Assignee: INTERNATIONAL BUSINESS MACHINES CORPORATION, ARMONK, NY (US)

(21) Appl. No.: 12/907,284

(22) Filed: Oct. 19, 2010

(51) Int. Cl. H04N 7/18

(52) U.S. Cl. 348/143; 348/E07.085

(57) ABSTRACT

A region within a field of view of a video stream associated with an Internet Protocol (IP) camera can be identified. The region can be associated with one or more logical boundaries which can correspond to one or more physical boundaries within a customer service area of a place of business. The customer service area can be a domain in which a customer interacts with a business product and/or a business service. A customer crossing a logical boundary of the customer service area can be detected in real-time. The detecting can be performed by a directional tripwire analytics which can comprise of an object tracking algorithm, a face detection functionality, and/or a shape detection procedure. The traffic flow associated with the region can be programmatically determined which can include flow density, flow rate, and flow speed.

### BACKGROUND

The present disclosure relates to the field of video surveillance and, more particularly, to monitoring traffic flow within a customer service area to improve customer experience.

Places of business such as retail stores and hospitality facilities aim to provide customers with a high quality customer experience. These businesses often have customer service areas which assist customers in various ways. Customer service areas such as point-of-sale (e.g., checkout register) are often high traffic zones which are subject to varying degrees of traffic flow. For instance, during peak hours, a customer service desk can become saturated with customers seeking assistance with purchases. This saturation can lead to long wait times for customers, frustration, and decrease in the quality of a customer experience. Many times, special occasions such as holiday season sales can result in unexpectedly high volumes of customer presence. In these situations, overcrowding and bottlenecks can occur regularly. These can negatively affect a customer's purchasing experience, exhaust workers (e.g., handling frustrated customers), and lead to unfavorable shopping conditions.

A current solution is to utilize personnel to monitor these customer services areas to control the traffic flow. However, these personnel are usually tasked with many other responsibilities and therefore cannot fully address all customer traffic flow situations. For example, a floor supervisor can be tasked with monitoring customer service areas in addition to managing workers. Consequently, a new mechanism is needed for improving customer experience by moderating customer traffic flow through customer service areas.

### SUMMARY

A region within a field of view of a video stream associated with an Internet Protocol (IP) camera can be identified. The region can be associated with one or more logical boundaries which can correspond to one or more physical boundaries within a customer service area of a place of business. The customer service area can be a domain in which a customer interacts with a business product and/or a business service. A customer crossing a logical boundary of the customer service area can be detected in real-time. The detecting can be performed by directional tripwire analytics which can be comprised of an object tracking algorithm, a face detection functionality, and/or a shape detection procedure. The traffic flow associated with the region can be programmatically determined which can include flow density, flow rate, and flow speed.

### BRIEF DESCRIPTION OF THE SEVERAL VIEWS OF THE DRAWINGS

FIG. 1 is a schematic diagram illustrating a system for monitoring traffic flow within a customer service area to improve customer experience in accordance with an embodiment of the inventive arrangements disclosed herein.

FIG. 2 is a flowchart illustrating a method for monitoring traffic flow within a customer service area to improve customer experience in accordance with an embodiment of the inventive arrangements disclosed herein.

FIG. 3 is a schematic diagram illustrating a system for monitoring traffic flow within a customer service area to improve customer experience in accordance with an embodiment of the inventive arrangements disclosed herein.

### DETAILED DESCRIPTION

The present disclosure is a solution for monitoring traffic flow within a customer service area to improve customer experience. In the solution, a video analytics system can be utilized in conjunction with a collection of Internet Protocol cameras to monitor traffic flow within pre-defined regions of a customer service area. For example, the region can include an aisle formed between handrails located on either side of a checkout register (e.g., checkout aisle). The analytics system can determine when a customer enters and/or exits a region within the customer service area which can be utilized to measure the traffic flow for the region. In one instance, threshold values can be established to trigger notifications based on traffic flow metrics. For instance, when traffic flow volume is greater than a threshold value, personnel can be notified that a region is experiencing long wait times.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

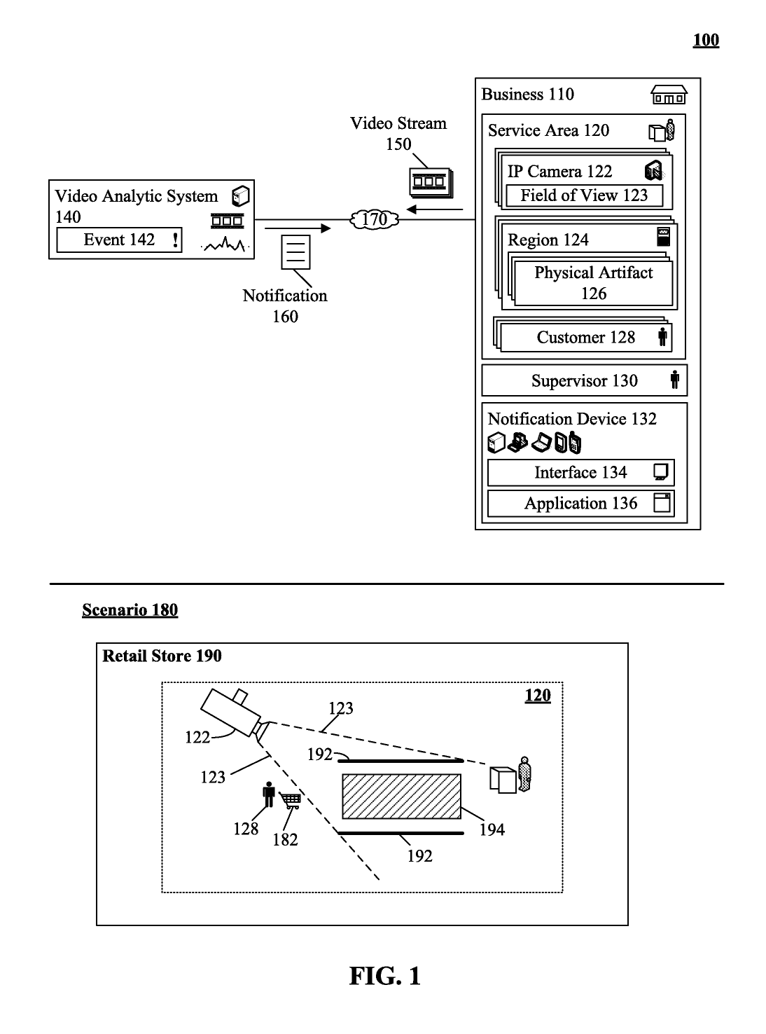

FIG. 1 is a schematic diagram illustrating a system 100 and scenario 180 for monitoring traffic flow within a customer service area to improve customer experience in accordance with an embodiment of the inventive arrangements disclosed herein. In system 100, a business 110 (e.g., retail store 190) can utilize Internet Protocol (IP) camera 122 and video analytic system 140 to improve and/or moderate customer 128 traffic flow through a service area 120 (e.g., checkout register). Scenario 180 illustrates one potential embodiment where a retail store 190 (e.g., business 110) can utilize system 100 to enable traffic flow monitoring. Traffic flow can include, but is not limited to, customer flow rate, speed, density, and the like.

Video analytic system 140 can determine customer 128 flow through tripwire analytics which can be implemented through the use of sensors such as IP camera 122. It should be appreciated, additional sensors including, but not limited to, motion detectors, pressure sensitive materials, Radio Frequency Identification (RFID) tags, and the like can be utilized to assist system 100 in determining customer 128 traffic flow. As used herein, tripwire analytics can include identifying an object crossing a logical boundary associated with region 124. A logical boundary can be a digital representation of a physical boundary. For instance, in scenario 180, the perimeter of region 194 can be a physical boundary which can be translated into a logical boundary within the field of view 123 of IP camera 122. Tripwire analytics can include directional tripwire analytics which can be used to determine the trajectory of an object in relation to region 124 and associated boundaries. It should be appreciated that a portion of a region 124 (e.g., a side) can be utilized as a boundary to permit distinctive tripwires to be established for a region. For example, in scenario 180, the short sides of rectangular region 194 can be defined as entry and exit boundaries.

IP camera 122 can monitor region 124 which can be within the field of view 123 of camera 122. It should be understood that multiple regions 124 can exist within the field of view 123 of camera 122 which can be monitored similiarly. Activity (e.g., customer 128 movement) occurring within field of view 123 can be conveyed as video stream 150 to analytic system 140. System 140 can utilize specialized triggers to determine event 142 occurrence within region 124. Event 142 occurrence can be determined based on customer 128 movement into and out of region 124 via boundary crossing parameters. For example, in scenario 180 when a customer 128 enters region 124, an event can be triggered indicating the presence of a customer 128 within region 124.

Based on system 140 configuration, triggers can be configured to establish an event of importance. For instance, system 140 can be configured to determine when a region 124 is occupied by too many customers resulting in a traffic overflow. When an event 142 occurrence is determined, notification 160 can be conveyed to notification device 132 which can be presented within interface 134. For instance, when a region 124 is determined to have a bottleneck, a notification 160 can be communicated to a supervisor 130′s mobile phone indicating a bottleneck has occurred at region 124.

Notification 160 can be a message comprising event information associated with a region 124. Event information can include, but is not limited to, event identifier, date/timestamp, event description, service area identifier, service area location, event status, and the like. Notification 160 can be conveyed in one or more formats including, but not limited to, email, text message, Short Message Service (SMS), voice call, instant message (IM), desktop alert, pager alert, Really Simple Syndication (RSS) update, facsimile, and the like. In one instance, notification 160 can be a message of a issue tracking system enabling tracking, auditing, escalation, and the like. In the instance, notification 160 can include task assignment properties which enables accountability within the system.

In one embodiment, a presence server (not shown) can be utilized to deliver location based notifications to relevant devices 132. In the instance, a notification can be conveyed to one or more notification devices determined to be in proximity of a service area requiring regulation. That is, multiple notifications can be communicated to proximate personnel. To ensure measured response and mitigate potential personnel overload at a service area, notification 160 can include real-time and/or automated job approval. For example, as a supervisor 130 carrying device 132 approaches proximity of service area, the application 136 can automatically trigger acceptance of the job and notify appropriate personnel that supervisor 130 is tasked with the job.

In another embodiment, notification 160 can be conveyed to a centralized location such as a back-office (e.g., back-office computer) which can operate as a dispatch. In one configuration of the instance, notification can be conveyed to a network printer within a back-office which can be produced as a physical hard-copy (e.g., trouble ticket report).

In yet another embodiment, system 100 can utilize existing retail store components to notify relevant entities. In the embodiment, fixed notification components can be utilized to convey notifications and/or notification information. Notification components can include, but not limited to, loudspeakers, lighting fixtures (e.g., strobe beacons), and the like. For example, a proximate worker can be notified of a bottleneck situation via a callbox loudspeaker announcement.

As used herein, business 110 can refer to a place of business where customers can interact with a business product and/or business service. Business 110 can include, but is not limited to, a retail store, a restaurant, a hotel, a kiosk, a sidewalk, and the like. Retail store can include, but is not limited to, a supermarket, a department store, a shopping mall, a warehouse store, variety store, general store, a convenience store, a marketplace, and the like. Business 110 can be a physical establishment comprising of, but not limited to, service area 120, IP camera 122, supervisor 130, notification devices 132, worker (not shown), and the like.

IP camera 122 can be a hardware/software component able to surveil one or more portions of region 124. Camera 122 can include, but is not limited to, video camera, still-image camera, high speed camera, and the like. Camera 122 functionality can include, but is not limited to, pan-tilt-zoom, auto-tracking, low-light operation, indoor, outdoor, and the like. Camera 122 can be positioned/mounted using traditional approaches including, but not limited to, ceiling mounted (e.g., overhead), on a pole, affixed to a post, attached to a building, mounted to a wall, and the like. Camera type and positioning is not limited to arrangements disclosed herein and can include numerous configurations permitting a view of region 124. Camera 122 can be a centralized IP camera communicatively linked to system 140 via network 170. It should be appreciated, camera 122 can be communicatively linked to a local and/or remote network associated with business 110 (e.g., Local Area Network/Wide Area Network).

Due to limitations of IP camera 122 technology (e.g., image sensor) and real-world environments (e.g., low lighting) treatment of video stream 150 can be performed by system 140 to enable improved event detection. Treatment can include, but is not limited to, noise reduction, perspective correction, vignette reduction, and the like.

As used herein, field of view 123 can be the extent of the observable area within business 110 that can be visible to camera 122 during a temporal interval. Field of view 123 can include, but is not limited to, angular, linear, and the like. Field of view 123 can be static or dynamic based on camera 122 positioning, functionality, and the like. For instance, due to lighting conditions, imaging range within field of view 123 can dynamically alter throughout the day. To compensate for these limitations, multiple IP cameras 122 can be utilized within service area 120 and/or region 124.

Region 124 can be a two-dimensional region within service area 120 which can be linked to a logical bounded region within IP camera 122 field of view 123. Region 124 can be formed from one or more physical artifacts within service area 120. For instance, handrails 192 within area 120 can be used to create a rectangular logical region 194 which can be monitored using camera 122 via field of view 123. Region 124 can conform to an arbitrary size, shape (e.g., geometric, shapes, non-geometric shapes), and the like. In one instance, the region 124 can be created manually using a client-side surveillance application interface (e.g., application 136). In the instance, the region can be constructed via a selection tool, drawing tool, and the like. For example, a customer service area can be graphically presented within application 136 which can permit a user to draw a bounded region which corresponds to region 124. In one embodiment, region 124 can be associated with a status value. In the embodiment, region 124 can be marked active or inactive enabling dynamic monitoring of critical customer service areas. For instance, surveillance of a region which is denoted inactive can be suspended until the region state is changed to active.

In one embodiment, region 124 can be automatically determined by system 140. In the embodiment, object detection, analytics history, and the like can be utilized to automatically determine region 124. For example, handrails 192 can be automatically identified and region 124 can be established (e.g., floor boundary 194) which can be monitored for customer 128 detection.

In one embodiment, region 124 can span one or more IP cameras 122. In the embodiment, the use of image manipulation techniques such as image stitching can be employed to permit customer tracking associated with region 124. In one instance, region 124 can have a one-to-one correspondence to service area 120. That is, region 124 can encompass the entire surface area of the service area 120. In one instance, region 124 can be dynamically established utilizing customization settings. In the instance, region 124 can be manually mapped permitting floor plan specific areas to be achieved. That is, user-specified tripwires can be constructed based on business 110 requirements.

Physical artifact 126 can be one or more physical objects within field of view 123 which can be utilized to establish a boundary. Artifact 126 can be a temporary and/or permanent structure including, but are not limited to, handrails, adhesive tape, flagging tape, safety cones, stairways, escalators, guide rails, doorways, walls, and the like. In one instance, physical artifact 126 can span one or more IP cameras 122. For example, artifact 126 can be a delicatessen counter at a grocery store. In another instance, artifact 126 can comprise of smaller objects forming a single structure. For instance, artifact 126 can comprise of multiple products stacked together to form a product display.

Customer 128 can be a human agent (e.g., patron) interacting with one or more products and/or services associated with business 110. Customer 128 can include one or more human agents such as individuals, families, groups, and the like. Customer 128 can be detected utilizing directional tripwire analytics which can include video tracking It should be appreciated that system 140 can be triggered via objects which can include humans (e.g., customer 128), vehicles (e.g., automobiles), shopping carts 182, and the like.

Notification device 132 can be a hardware/software component permitting supervisor 130 interaction with, IP camera 122, system 140, and the like. Device 132 can comprise of, but is not limited to, interface 134, application 136, human interface components (e.g., keyboard, mouse, touchpad, etc), and the like. Notification device 132 can include, but is not limited to, desktop computer, laptop, netbook, tablet computing device, mobile phone, portable computing device, portable digital assistant (PDA), and the like. In one instance, notification device 132 can be a two-way radio carried by a business 110 personnel. For example, notification device 132 can be a push-to-talk radio connected to a headset worn by a supervisor 130. Notification device 132 can be communicatively linked to a business 110 operations center and/or system 140 via one or more networks (e.g., network 170).

Interface 134 can be a user interface associated with notification device 132. Interface 134 can be an audio/visual component including, but not limited to, physical display screen, loudspeaker (e.g., piezo-electric speaker), and the like. In one instance, interface 134 can be associated with a checkout register, kiosk, and the like. Interface 134 can be associated with an application 136 which can present event 142 information, notification 160, and the like. In one embodiment, interface 134 can be a graphical user interface (GUI) associated with application 136.

Application 136 can be a software application able to communicate with video analytic system 140. Application 136 can communicate event information 140, notification 160 information, configuration settings, trigger settings, and the like. In one instance, application 136 can be a Web-based application comprising of a Web-based interface (e.g., a Web browser). In the instance, application 136 can be a component of a Service Oriented Architecture (SOA) framework. In one instance, application 136 can be a widget within a portal Web page. In the instance, notification updates can be conveyed to the widget via Asynchronous Javascript and Extensible Markup Language (AJAX) communication). In another instance, application 136 can be a component of a JAVA 2 ENTERPRISE EDITION (J2EE) software. In one embodiment, application 136 can permit searching system 140. In the embodiment, search parameters can include, but is not limited to, event 142 information, event 142 metadata, notification 160, triggers, and the like.

As used herein, video analytic system 140 can be an off-premise system which can be communicatively linked to one or more local and/or remote systems permitting the enablement of system 100. For instance, video analytic system 140 can be a component of an IBM SMART SURVEILLANCE SYSTEM. As used herein, network can include any combination of wired and/or wireless computing technologies interconnecting system 100 components. Further, it should be understood that supervisor 130 can refer to any personnel associated with business 110 including, but not limited to, workers, contractors, and the like.

Due to spacial limitations, permanent physical environments, and floor plan configurations, IP camera 122 need not reside within service area 120, but can exist anywhere within business 110 that permits field of view 123 to monitor one or more portions of region 124. It should be appreciated, false positives can be mitigated through use of object detection, grouping detection, and other techniques known to those skilled in the art of digital surveillance. For instance, a shopping cart 128 abandoned within the region 124 of a customer service area 120 can be distinguished from a customer passing through the service area 120.

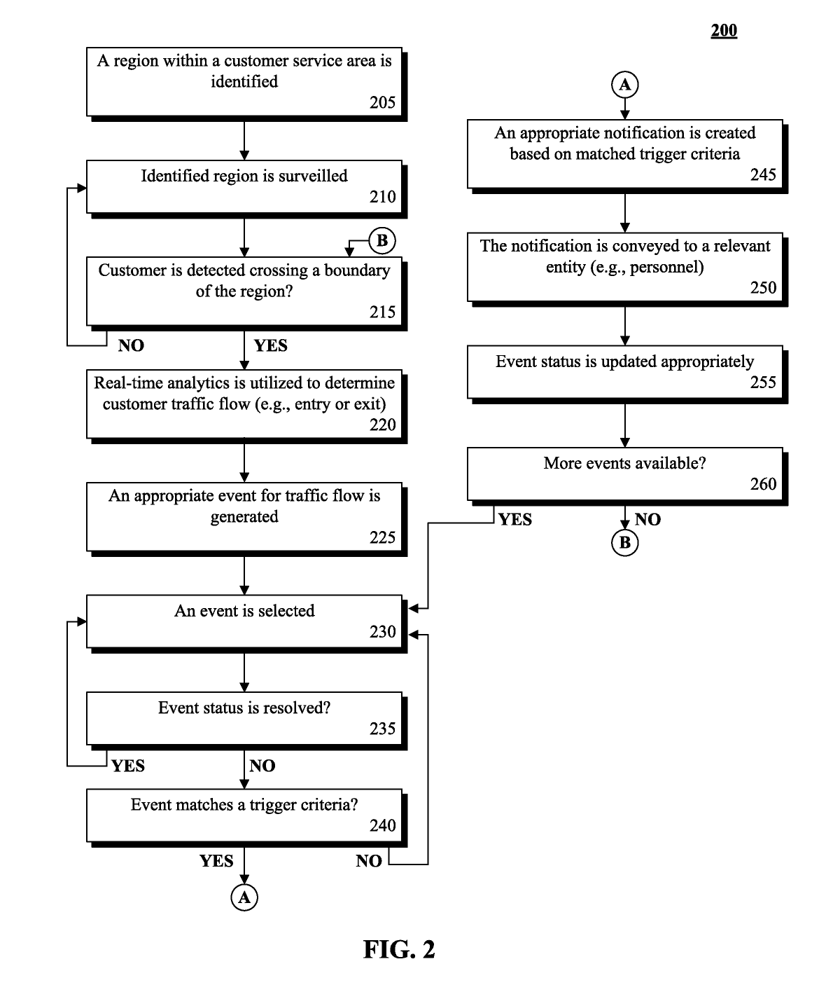

FIG. 2 is a flowchart illustrating a method 200 for monitoring traffic flow within a customer service area to improve customer experience in accordance with an embodiment of the inventive arrangements disclosed herein. Method 200 can be performed within the context of system 100, 300. In method 200, a customer service area can comprise of a region which can be serveilled to determine customer traffic flow for the region. Based on traffic flow conditions various response scenarios can be initiated through a notification system which can selectively alert personnel to flow state.

In step 205, a region within a customer service area can be identified. In step 210, the identified region can be surveilled. In step 215, if a customer is detected crossing the boundary of the region, the method can proceed to step 220, else return to step 210. In step 220, real-time analytics can be utilized to determine customer traffic flow within the identified region. In step 225, an appropriate event for traffic flow can be generated. In one embodiment, the generated event can be recorded within an event database. In the embodiment, the event database can be polled at intervals to determine events to be selected for analysis.

In step 230, an event can be selected to be analyzed. Event selection can be determined based on one or more user selectable criteria. Criteria can include, but is not limited to, temporal conditions, location (e.g., customer service area), event status, and the like. In step 235, if the selected event status is resolved, the method can return to step 230, else proceed to step 235. In step 240, if the selected event matches a trigger criteria, the method can continue to step 245, else return to step 230. Trigger criteria can include, but is not limited to, one or more threshold values, customer flow rate through an identified region, customer flow rate through multiple identified regions, customer flow density over an interval, and the like.

In step 245, an appropriate notification can be created based on matched trigger criteria. Notification can include personnel notification, system event notifications, and the like. In one instance, notification can be used to alert other components associated with method 200 of an event occurrence. In step 250, the notification can be conveyed to a relevant entity (e.g., personnel). In one embodiment, notification can be associated with a recommendation For instance, notification can be conveyed to a checkout personnel indicating staffing an additional checkout aisle can improve traffic flow. In step 255, the event status can be updated appropriately. Status updates can occur in real-time enabling method 200 to reflect real-time conditions of an identified region. Updates can include, but is not limited to, event state changes, event information updates, and the like. In step 260, if more events are available, the method can return to step 230, else proceed to step 215.

Drawings presented herein are for illustrative purposes only and should not be construed to limit the invention in any regard. Steps 230-250 can be continuously performed for each event generated. It should be appreciated that the method 200 can be continually performed selectively based on conditions including, but not limited to, the duration of the region's existence, during special hours of operation (e.g. fire sales), and the like. Method 200 can be initiated in response to dynamically identified regions. For instance, as regions change state, from inactive to active, method 200 can be commenced.

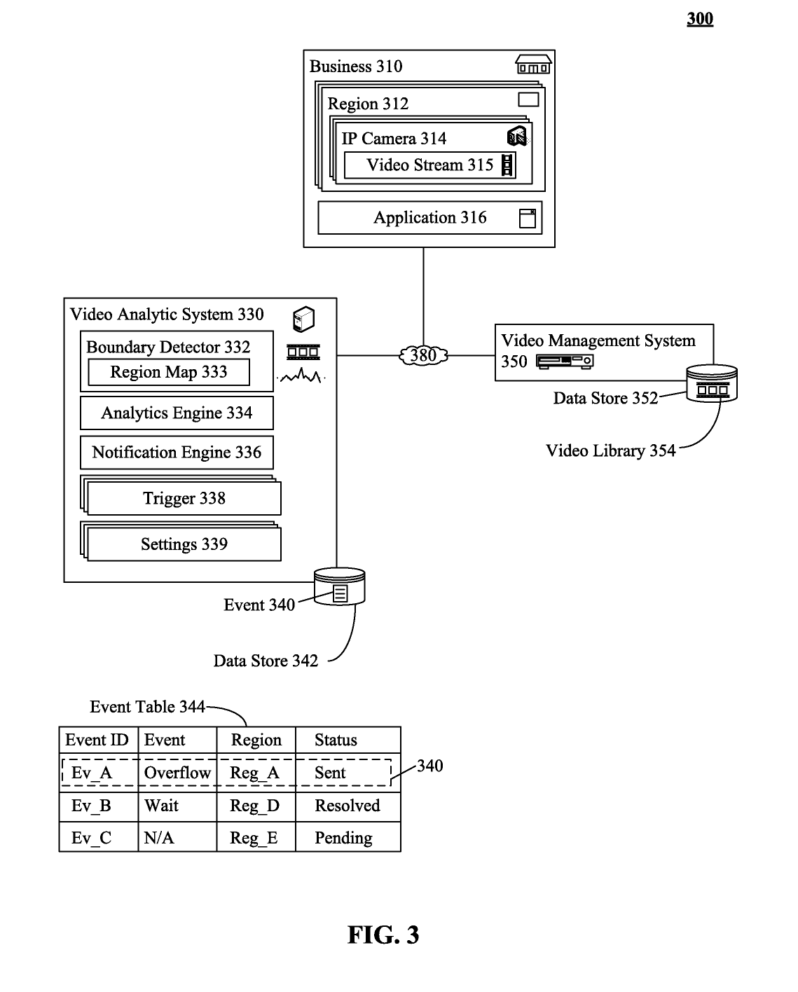

FIG. 3 is a schematic diagram illustrating a system 300 for monitoring traffic flow within a customer service area to improve customer experience in accordance with an embodiment of the inventive arrangements disclosed herein. System 300 can be present in the context of system 100 and/or method 200. In system 300, a video analytics system 330 can perform directional tripwire analytics to determine customer traffic flow within region 312 of business 310. System 300 can be communicatively linked via network 380. A video stream 315 from Internet Protocol (IP) camera 314 can be received by analytic system 330 and/or video management system 350. In one embodiment, system 330 can receive and analyze video stream 315 in real-time. In another embodiment, system 330 can communicate with video management system 350 to obtain video library 354 from data store 352 which can be processed in real-time.

Video analytic system 330 can be a component of a security and/or surveillance framework for analyzing a video stream from IP camera 314 and determining an event occurring associated with region 312. Video analytic system 330 can comprise of, but is not limited to, boundary detector 332, analytics engine 334, notification engine 336, trigger 338, settings 339, data store 342, and the like. In one instance, system 330 can be a component of an IBM Middleware for Large Scale Surveillance (MILS) software.

Boundary detector 332 can be a hardware/software component for determining a tripwire triggering incident. Boundary detector 332 can process video stream 315 utilizing one or more analytic techniques including, but not limited to, object detection, face detection, path detection, and the like. Detector 332 can utilize region mapping information (e.g., region map 333) to identify tripwire incidents occurring within video stream 315.

Region map 333 can be an artifact able to correspond to a physical boundary of region 312 with a logical boundary within a field of view of IP camera 314. Map 333 can permit identification of entry boundaries, exit boundaries, and the like. In one instance, map 333 can be a template permitting derivative mappings to be created. For instance, map 333 can be copied to generate identical mapping parameters for multiple regions 312 easily. Map 333 can be stored within boundary detector 332, application 316, system 330, data store 342, and the like. In one instance, map 333 can be a metadata document such as an Extensible Markup Language (XML) document. In the instance, a coordinate system can be utilized to specify a region within the document. In one embodiment, map 333 can be associated with a planogram. In the embodiment, a planogram can be used programmatically obtain region 312 information (e.g., location, size, etc).

In one instance, multiple region mappings can be associated with a single region 312 via map 333. In the instance, region maps can be selectively associated with a region based on one or more conditions, including, but not limited to, time, traffic flow, and the like. For instance, during peak hours, a larger region map can be employed to accommodate increased traffic flow without generating excessive events and/or notifications.

Analytics engine 334 can be a hardware/software component permitting responsive monitoring of traffic flow within region 312. In one instance, analysis of video stream 312 by engine 334 can be conveyed to system 350 and committed to data store 352. That is, video stream 315 metadata can be cataloged and stored within system 350 which can be utilized in performing complex analytics. Engine 334 can be used to identify behavior patterns, including, but not limited to, peak times, non-peak times, flow stagnation, and the like. For instance, peak trends (e.g., peak hours) can be used to permit business 310 to institute a schedule to open more customer services areas accordingly. Engine 334 can generate statistics which can be conveyed to application 316 which can assist personnel in determining flow trends.

When a tripwire incident occurs, analytics engine 334 can be used to determine an event occurrence associated with region 312. In one instance, queue checking logic can be utilized to define a limit on the queue size (e.g., number of customers in line) associated with region 312. In the instance, an internal counter can be assigned for each region 312 which can be compared against a threshold value (e.g., queue size) to determine an event occurrence. For example, the counter can be incremented or decremented when a customer enters or leaves region 312. In one embodiment, when the queue size exceeds the threshold (e.g., trigger 338), an alert can be generated which can result in the creation of event 340. The alert can correspond to a real-time alert associated with an IBM SMART SURVEILLANCE ANALYTICS system. In one instance, the event 340 can be stored within data store 342. In another instance, the event 340 can be conveyed to notification engine 336 which can be processed into a notification.

Notification engine 336 can be a hardware/software component able to communicate notifications in response to event 340. In one instance, notification engine 336 can receive alerts from analytics engine when an event 340 is generated. In the instance, engine 336 can convey a notification comprising of event information which can be obtained from event table 344. In another instance, notification 336 can poll event table 344 to determine events which require notifications to be conveyed to relevant entities (e.g., personnel). It should be appreciated engine 336 can perform additional notification operations required to enable the functionality of system 300.

Trigger 338 can be one or more values utilized for determining an event occurrence. Trigger 338 can include, but is not limited to, threshold values, traffic flow density, traffic flow speed, traffic flow, queue size, timing information, and the like. Trigger 338 can be manually and/or automatically determined based on system 330 configuration. In one instance, trigger 338 can be heuristically determined based on historic event occurrence trends. In the embodiment, video library 354 can be analyzed to determine triggers which can be used to optimize traffic flow conditions. In one embodiment, trigger 338 can be configured utilizing application 316. In the embodiment, a graphical user interface within application 316 can enable user-customizable triggers to be established.

Settings 339 can be one or more configuration values for establishing the behavior of system 330. Settings 339 can include, but is not limited to, region 312 settings, mapping information, boundary detector 332 settings, analytics 334 configuration, notification 336 settings, indexing options, search configuration parameters, and the like. Settings 336 can allow configuration for additional sensors utilized by business 310 to assist in monitoring region 312. For instance, payment by a customer through a magnetic card reader (e.g., credit card reader) can be utilized as confirmation of a customer exiting a region 312. In one embodiment, settings 339 can permit business 310 specific profiles to be maintained. In the embodiment, application 316 can permit presentation and/or modification of settings 339 enabling customized behavior for each business 310. Further, settings 339 can support filters which can be utilized for searching, configuring triggers, and the like.

Event 340 can be an event log of an alert generated by analytics engine 334. Event 340 can include, but is not limited to, an event identifier, a timestamp, a location, a description, a video stream, and a status. Event 340 can include, but is not limited to, metadata (e.g., tags), user generated comments, priority values, and the like. Event 340 can be linked to one or more regions 312, customer service areas, and the like. In one embodiment, event 340 can be stored within an event table 344. Event table 344 can be associated with a database including, but not limited to, a Relational Database Management System (RDBMS), Object Oriented Database Management System (OODBMS), and the like. For instance, table 344 can be a portion of an IBM DB2 event database.

Video management system 350 can be a hardware/software component for storing video stream 315. Video management system 350 can include, but is not limited to, data store 352, video library 354, and the like. In one instance, video management system 350 can be an enterprise digital video recorder associated with a digital asset management software. In one embodiment, system 350 can be a component of video analytic system 330.

Drawings presented herein are for illustrative purposes only and should not be construed to limit the invention in any regard. It should be appreciated system 330 can be a component of an IBM SMART SURVEILLANCE ENGINE (SSE) software. In one instance, system 330 can be a component of a Software as a Service (SaaS) infrastructure. In the instance, system 330 can include one or more Web-services permitting real-time monitoring and notification of region 312. It should be appreciated, system 330 can permit information sharing which can include, but is not limited to, profile sharing, region map 333 sharing, trigger 338 dissemination, settings 339 distribution, and the like.

The flowchart and block diagrams in the FIGS. 1-3 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for monitoring traffic flow within a customer service area comprising:
identifying a region within a field of view of a video stream associated with a camera, wherein the region is associated with a plurality of logical boundaries, wherein the logical boundaries corresponds to a plurality of physical boundaries within a customer service area of a place of business, wherein the customer service area is a domain in which a customer interacts with at least one of a business product and a business service;
detecting in real-time or near real-time within the video stream a customer crossing at least one of the plurality of logical boundaries of the customer service area; and
programmatically determining the traffic flow associated with the region, wherein the traffic flow is at least one of a flow density, flow rate, and flow speed.

2. The method of claim 1, wherein the detecting is performed by a directional tripwire analytics, wherein the directional tripwire analytics is at least one of an object tracking algorithm, a face detection functionality, and a shape detection procedure.

3. The method of claim 1, wherein the customer service area is defined by at least one boundary associated with a physical artifact, wherein the physical artifact is at least one of a handrail, an adhesive tape, flagging tape, a pressure sensitive tape, and a painted demarcation.

4. The method of claim 1, further comprising:
generating an alert based on the determining and when the alert matches a trigger within the video analytics system, creating an event for the alert, wherein the event comprises of at least one of a timestamp, a location, and a status; and
composing a notification associated with the event and conveying the notification to a relevant entity associated with the retail store, wherein the entity is at least one of a notification component and a notification device.

5. The method of claim 4, wherein the notification is conveyed in a format conforming to at least one of an email, text message, voice message, Instant Message (IM), pager alert, and facsimile.

6. The method of claim 4, wherein the notification is conveyed to an entity proximate to the location associated with the event, and wherein the notification is conveyed to a centralized back-office computing device.

7. The method of claim 4, wherein the notification is conveyed to a fixed notification device, wherein the fixed notification device is at least one of a loudspeaker and a lighting fixture.

8. The method of claim 2, wherein determining is performed via directional tripwire analytics associated with an IBM SMART SURVEILLANCE SYSTEM.

9. The method of claim 1, wherein the detecting is assisted by input from sensors within the place of business.

10. A system for monitoring traffic flow within a customer service area comprising:
a region within a customer service area of a place of business defined within a field of view of a camera, wherein the region comprises of at least one physical boundary, wherein the at least one physical boundary corresponds to at least one logical boundary, wherein the logical boundary is a virtual tripwire associated with a directional tripwire analytic;
an analytics engine able to determine a entity triggering the directional tripwire analytic, wherein the triggering is responsive to identifying an entity intersecting the virtual tripwire within a video stream associated with the IP camera;
a notification engine configured to generate a notification of an event occurrence within the region, wherein the event occurrence is a traffic flow condition associated with the region; and
a trigger associated with the directional tripwire analytic comprising of at least one of a criteria and an action, wherein the criteria is associated with a traffic flow property of the region, wherein the property is at least one of a flow rate, flow density, and flow speed.

11. The system of claim 10, further comprising:
a video management system able to store the video stream associated with the IP camera; and
a video library configured to store metadata associated with the video stream, wherein the metadata comprises of at least a video analytics information and a user specified information.

12. The system of claim 10, further comprising:
a presence server configured to convey location information of an entity proximate to a region to the notification engine, wherein the entity is at least one of an worker and a notification device.

13. The system of claim 10 wherein the notification is presented within an application interface of a notification device, wherein the notification device is at least one of a back-office computing device, portable computing device, and a desktop computer.

14. The system of claim 10, wherein the notification comprises of at least one of a timestamp, a text description, a location, and a video stream.

15. The system of claim 10, wherein the claimed system is associated with an IBM MIDDLEWARE FOR LARGE SCALE SURVEILLANCE (MILS) software.

16. An apparatus including an interface for monitoring traffic flow within a customer service area comprising:
a tangible memory storing at least one computer program product;
a processor operable to execute the computer program product to cause the interface window to be displayed by the display hardware; and
the computer program product when executed by the processor being operable to identify a region within a field of view of a video stream associated with an Internet Protocol (IP) camera, wherein the region is associated with a plurality of logical boundaries, wherein the logical boundaries corresponds to a plurality of physical boundaries within a customer service area of a place of business, wherein the customer service area is a domain in which a customer interacts with at least one of a business product and a business service;
the computer program product when executed by the processor being operable to detect in real-time within the video stream a customer crossing at least one of the plurality of logical boundaries of the customer service area, wherein the detecting is performed by a directional tripwire analytics, wherein the directional tripwire analytics is at least one of an object tracking algorithm, a face detection functionality, and a shape detection procedure; and
the computer program product when executed by the processor being operable to programmatically determine the traffic flow associated with the region, wherein the traffic flow is at least one of a flow density, flow rate, and flow speed.

17. The apparatus of claim 16, further comprising:
when the traffic flow matches a trigger criteria, generating an event occurrence and performing a notification action.

18. The apparatus of claim 16, further comprising:
display hardware within with an interface window of a graphical user interface is displayed to a user;
wherein the computer program product presents a notification within the graphical user interface, wherein the notification presents traffic flow statistics associated the region within the customer service area.

19. The apparatus of claim 16, wherein the interface is associated with a computing application, wherein the computing application is a component of a Service Oriented Architecture.

20. The apparatus of claim 16, wherein the interface permits searching event occurrences by a plurality of search parameters, wherein the search parameter is at least one of a time, location, event type, and user-specified metadata.
